(19) United States
(12) Patent Application Publication
(10) Pub. No.: US 2025/0138495 A1
(43) Pub. Date: May 1, 2025

(54) METHOD AND SYSTEM FOR PROVIDING OPERATING CONDITION FOR MANUFACTURING APPARATUS

(71) Applicant: Hitachi, Ltd., Tokyo (JP)

(72) Inventor: Takeshi NAKAYAMA, Tokyo (JP)

(21) Appl. No.: 18/890,401

(22) Filed: Sep. 19, 2024

(30) Foreign Application Priority Data
Oct. 27, 2023 (JP) 2023-184496

(51) Int. Cl. G05B 13/04; G05B 13/02

(52) U.S. Cl. CPC G05B 13/048; G05B 13/0265

(57) ABSTRACT

An operating condition for a manufacturing apparatus that manufactures a product using a variation amount input step is provided in which an input device inputs a variation amount related to a predetermined operating condition. A model reading step reads, from memory, a model in which an input is the operating condition and an output is a characteristic value of the product. A target characteristic value is input for the product; and a predicted characteristic value distribution is calculated, using the model, and reflecting the variation amount related to the predetermined operating condition. An objective function is calculated based on the predicted characteristic value distribution and the target characteristic value; and an operating condition exploration step is performed in which a processor explores the predetermined operating condition that reduces the objective function. An operating condition output step is performed of outputting an operating condition that is a result of the exploration.

### CROSS-REFERENCE TO RELATED APPLICATION

The present application claims priority from Japanese application JP2023-184496, filed on Oct. 27, 2023, the content of which is hereby incorporated by reference into this application.

### BACKGROUND OF THE INVENTION

### 1. Field of the Invention

The present invention relates to a technique for providing an operating condition for a manufacturing apparatus, such as material informatics.

### 2. Description of Related Art

Hereinafter, a related art of plastic manufacturing using an extruder as a manufacturing apparatus will be described as an example of where the invention is applied.

In recent years, in pursuit of enhancing plastic functionality, a polymer alloy that exhibits functions by adding additives or fillers and mixing a plurality of polymers is studied. In order to improve such functions, more advanced kneading and dispersion techniques are important, and an extruder is used as a unit for accomplishing both a continuous production function and advanced kneading.

In an operation of the extruder during kneading, viscosity of a material inside the extruder is a highly important parameter, and a resin temperature is an example of one important indicator for determining the viscosity. In particular, in plastic manufacturing, when the resin temperature is excessively high, a material characteristic deteriorates. Therefore, it is necessary to accurately control a spatiotemporal resin temperature distribution inside the extruder. However, actually, it is not easy to accurately control a true resin temperature distribution inside the extruder.

One cause that makes it difficult to control the resin temperature distribution inside the extruder is that it is difficult to directly measure the resin temperature. Although a temperature sensor can be directly introduced into the extruder, it is difficult to obtain a three-dimensional distribution, and indirect internal temperature prediction is actually performed from the viewpoint of cost and maintainability. Examples of an indirect internal temperature prediction method include a study based on an insight in a small-scale test and a simulation.

In general, an operating condition exploration of the extruder, including a temperature, is studied with a small-scale testing machine before being performed on a large-scale mass-production machine. However, when scaling up using an insight obtained from the small-scale study, it is difficult to obtain the same kneading performance on a large scale as on the small scale by simply enlarging an equipment dimension proportionally. One reason for this is a problem of heat exchange. For example, a total amount of heat stored by a resin inside the extruder and an amount of heat generated by a reaction are proportional to a volume and thus change by a cube of a dimension ratio when scaling up, but a rate at which the heated resin comes into contact with an inner wall of a cylinder of the extruder to be cooled and controlled through heat exchange is proportional to an area and thus changes by a square of the dimension ratio when scaling up. Therefore, an optimum temperature condition obtained from the small-scale study is subjected to determination of whether a process itself is a “heat-transfer-dominated process” or a “process with low temperature-dependence” when scaling up, and an appropriate strategy is implemented according to the process.

Before plastic is actually mass-produced by a mass-production machine, in many cases, an operation of checking, by a simulation, a value of a temperature or the like that cannot be measured is performed. However, it is still difficult to perform, with a currently available simulator, a simulation in consideration of all operating condition parameters and all factors of an environment where an apparatus is located (external interferences such as a temperature and humidity).

For example, in the simulation, computation is often performed on an assumption that a fill rate inside the cylinder is 100%, and computational difficulty significantly increases when the fill rate is less than 100% due to presence of a gas-liquid interface. Therefore, even when the computation is performed by setting the fill rate to 100% in the simulation, there is actually a gas-liquid interface, and further, the temperature differs depending on a phase. Even in the same phase, it is conceivable that temperature distributions exist on various scales due to disturbances, and even if one point inside the cylinder is measured with a thermometer, a temperature variation is always observed.

A cylinder temperature is an operating condition parameter and is controlled at a constant temperature, but depending on a control method, the temperature constantly oscillates on a minute scale. In addition, a temperature variation that affects product quality due to an external interference out of control such as weather may occur. In related art, when such a temperature variation affects manufacturing quality and causes deviation from target quality, the quality is stabilized and optimized by a skilled worker by adjusting the operating condition parameter based on experience.

In recent years, with the progress of machine learning techniques, it is possible to construct a learning model for predicting a processing result from an operating condition. In addition, it is possible to explore an operating condition that satisfies a target processing result using such a learning model. However, in such an operating condition exploration technique, operating condition optimization in consideration of disturbances and external interferences is not yet performed, there are various external factors in an external interference such as differences in individual apparatus parts and differences in installation locations even with the same type of apparatus, and there is a problem that an impact of the external interference on the processing result is various and cannot be determined before installation of the apparatus. Therefore, there is a demand for optimization in consideration of a temporal dispersion or a probability distribution of condition values disturbed by disturbances and external interferences.

PTL 1 discloses a control system including a controller that controls a control amount of a control target for machining a workpiece in order to automatically prevent deviation of a machining result from a target state, and a predictor constructed based on a prediction model that receives an external interference as an input and outputs a set value for setting a quality characteristic value as a quality characteristic target value.

### CITATION LIST

### Patent Literature

PTL 1: JP2022-165143A

### SUMMARY OF THE INVENTION

There is a high possibility that a disturbance or external interference differs depending on an apparatus installation status or an apparatus operation status. Therefore, it is difficult to accumulate data in advance, and it is difficult to prepare a machine learning model that receives a variation amount as an input before an apparatus is introduced. In addition, not only before and after introduction of the apparatus but also before and after a transition of an operating condition such as transfer of the apparatus, replacement of parts of the apparatus, and scaling up from development to mass production, it is often difficult to prepare in advance a machine learning model that receives a variation amount after the transition as an input.

There is a demand for a method for providing a variation-resistant operating condition, which can obtain a target processing result even when there is a disturbance or external interference that cannot be anticipated in advance. An object of the invention is to provide a robust operating condition resistant to disturbances and external interferences.

A preferred aspect of the invention is a method for providing an operating condition for a manufacturing apparatus that manufactures a product using an input device, an output device, a processor, and a memory, the method including: a variation amount input step in which the input device inputs a variation amount related to a predetermined operating condition; a model reading step in which the processor reads, from the memory, a model in which an input is the operating condition and an output is a characteristic value of the product; a target characteristic value input step in which the input device inputs a target characteristic value of the product; a predicted characteristic value distribution calculation step in which the processor calculates, using the model, a predicted characteristic value distribution reflecting the variation amount related to the predetermined operating condition; an objective function calculation step in which the processor calculates an objective function based on the predicted characteristic value distribution and the target characteristic value; an operating condition exploration step in which the processor explores the predetermined operating condition that reduces the objective function; and an operating condition output step of outputting an operating condition that is a result of the exploration.

Another preferred aspect of the invention is a system for providing an operating condition for a manufacturing apparatus that manufactures a product from a raw material, the system including: a variation amount setting unit configured to receive, from an input machine, a variation amount related to a predetermined operating condition; a predictor configured to receive the predetermined operating condition and the variation amount, and output a predicted characteristic value distribution of the product using a model in which an input is an operating condition and an output is a characteristic value of the product; a target characteristic value setting unit configured to receive, from the input machine, a target characteristic value that is a target characteristic value of the product; an objective function setting unit configured to set an objective function based on the predicted characteristic value distribution and the target characteristic value; an explorer configured to explore the predetermined operating condition that reduces the objective function; and an output unit configured to output the explored operating condition.

According to the invention, it is possible to provide a robust operating condition resistant to disturbances and external interferences.

### BRIEF DESCRIPTION OF THE DRAWINGS

FIG. 1 is a flowchart showing a procedure from a start to an output of a proposed operating condition in a method according to an embodiment.

FIG. 2 is a functional block diagram showing a method for providing an operating condition for a manufacturing apparatus according to the embodiment.

FIG. 3 is a block diagram showing a hardware structure example of a system for providing an operating condition for a manufacturing apparatus according to the embodiment.

FIG. 4 shows a configuration example of a processing condition derivation system in a first embodiment.

FIG. 5 is a graph showing a change over time in a value observed with a temperature sensor in a situation where a temperature control target value is 220° C. in the first embodiment.

FIG. 6 is a graph showing a change over time in a value observed with a temperature sensor in a situation where the temperature control target value is 180° C. in the first embodiment.

FIG. 7 is a graph showing a relationship between an operating condition temperature and product quality in the issue of the first embodiment.

FIG. 8 is a functional block diagram showing a system for providing an operating condition for a manufacturing apparatus according to the embodiment.

### DESCRIPTION OF EMBODIMENTS

Hereinafter, embodiments of the invention will be described with reference to the drawings. The invention is not to be construed as being limited to the description of the embodiments described below. It will be easily understood by those skilled in the art that the specific configuration can be changed within a range not departing from the idea or spirit of the invention. In order to facilitate understanding of the invention, the position, size, shape, and the like of each configuration shown in the drawings and the like in the present specification may not represent the actual position, size, shape, and the like. Therefore, the invention is not limited to the positions, sizes, shapes, and the like disclosed in the drawings and the like.

In the configurations of the embodiments described below, the same portions or portions having similar functions are denoted by the same reference signs in different drawings, and redundant description thereof may be omitted. When there are a plurality of components having the same or similar functions, the description may be made by assigning the same reference signs thereof with different subscripts. However, when it is not necessary to distinguish the plurality of components, the description may be made by omitting the subscripts.

Notations of “first”, “second”, “third”, and the like in the present specification are provided to identify components and do not necessarily limit the number, the order, or the content thereof. A number for identifying a component is used for each context, and a number used in one context does not necessarily indicate the same configuration in another context. This does not prevent a component identified by a certain number from also having a function of a component identified by another number.

Publications, patents, and patent applications cited in the present specification constitute a part of the description of the present specification as they are. In the present specification, a component represented by a single form includes a plural form unless the context clearly indicates otherwise.

A method for providing an operating condition for a manufacturing apparatus that manufactures a product from a raw material, which is an example of an embodiment to be described in detail below, includes: a step of inputting a variation amount related to at least one operating condition parameter by an input machine; a step in which a processor reads, from a memory, a model in which an input is an operating condition and an output is a characteristic value of the product; a step of inputting a target characteristic value of a target workpiece by the input machine; a step of calculating, by the processor, a predicted characteristic value distribution in consideration of the variation amount from the model; a step of calculating, by the processor, an objective function based on a difference between the predicted characteristic value distribution and the target characteristic value; a step of exploring, by the processor, the operating condition input to the model to reduce the objective function based on the difference; and a step of outputting a result of the explored operating condition.

### Common Part

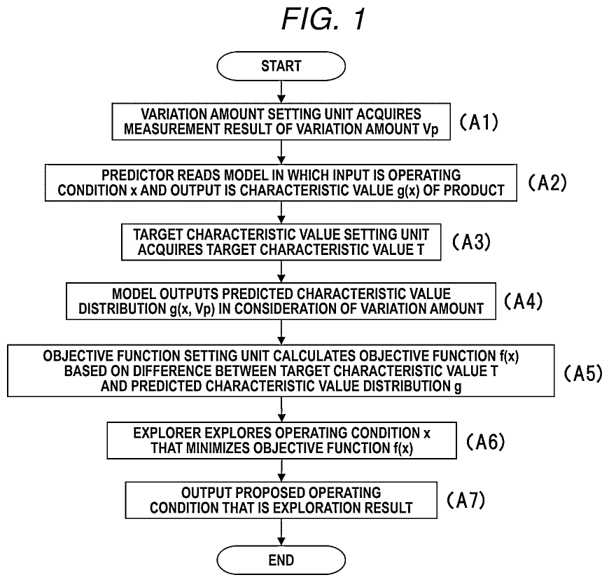

FIG. 1 is a flowchart showing a series of procedures from a start to an output of a proposed operating condition.

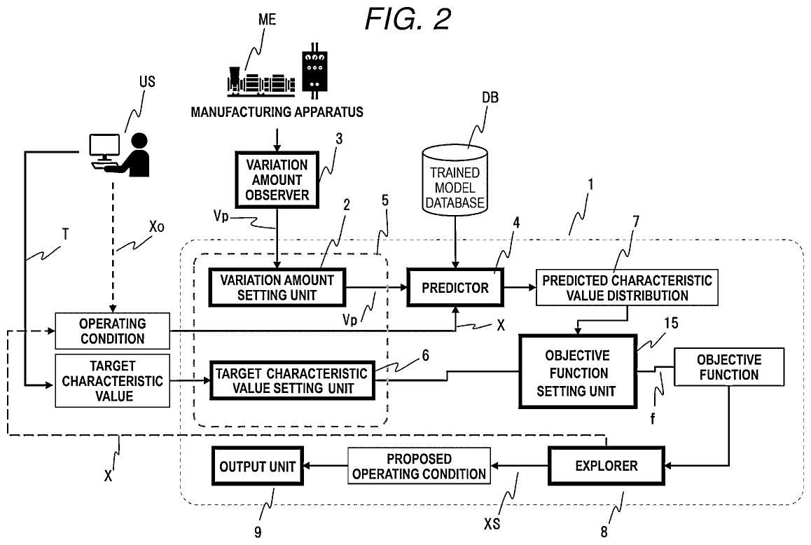

FIG. 2 is a functional block diagram showing a configuration example of a system 1 that provides an operating condition. An operation principle of the system 1 that provides the operating condition in FIG. 2 will be described below with reference to the flowchart in FIG. 1.

In FIG. 1, first, a variation amount setting unit 2 receives a variation amount Vp from a variation amount observer 3 such as a physical sensor (A1). The variation amount Vp is not necessarily one-dimensional, and for example, it is conceivable that a plurality of types of physical quantities through which a state of a manufacturing apparatus ME can be observed by a sensor such as a temperature or a pressure are targets. Hereinafter, an n-th type of a variation amount component of the variation amount Vp is expressed as Vpn. Information acquired by the variation amount observer 3 from the manufacturing apparatus ME is mainly change-over-time data, which is basically considered to be dependent on an operating condition X in many cases.

Next, a predictor 4 reads, from a trained model database DB, a trained model in which an input is the operating condition X and an output is a predicted characteristic value g(X) of a product (A2). Here, the trained model is not necessarily read from the database, and any form may be used as long as the trained model is simply read. The operating condition X is generally multi-dimensional and includes a plurality of operating condition parameters Xm.

Next, a target characteristic value setting unit 6 receives a target characteristic value T (A3). The target characteristic value T is not necessarily a one-dimensional quantity, and a specific target numerical value such as a mechanical characteristic value or an optical characteristic value is specified by a user US. An execution order of (A1) to (A3) is optional.

Next, the predictor 4 creates a predicted characteristic value distribution 7 in consideration of the variation amount Vp using the trained model (A4). The trained model is created in advance using a known machine learning technique. As methods for creating the predicted characteristic value distribution 7, there are three methods below using the variation amount component Vpn and a most relevant operating condition parameter Xn. Here, (1-1) is least computationally expensive, and (1-3) is most computationally expensive but has highest performance.

For example, the operating condition parameter Xn is a set temperature at a predetermined location A of the manufacturing apparatus ME, and the variation amount component Vpn is a temperature change at the predetermined location A of the manufacturing apparatus ME. An expression format of the variation amount component Vpn is optional, and for example, based on time-series data of a temperature acquired by the variation amount observer 3, the variation amount component Vpn can be converted into time-series data such as a positive variation value or a negative variation value from the set temperature that is the operating condition parameter Xn. An absolute value of a maximum positive variation value is referred to as Vpnp, and an absolute value of a maximum negative variation value is referred to as Vpnm based on the set temperature that is the operating condition parameter Xn.

(1-1): Two points, that is, a lower variation limit predicted characteristic value g(Xn−Vpnm) and an upper variation limit predicted characteristic value g(Xn+Vpnp) are calculated, and the two points are used as the predicted characteristic value distribution 7 for the variation amount of the n-th type.

(1-2): A predicted characteristic value is calculated at an exploration point selected by a design-of-experiments method (DoE) according to a number of explorations specified in advance by the user US or a number of explorations initially set in the system in a range from a lower variation limit (Xn−Vpnm) to an upper variation limit (Xn+Vpnp) of the operating condition parameter Xn, and the calculated predicted characteristic value is used as the predicted characteristic value distribution 7 for the variation amount of the n-th type.

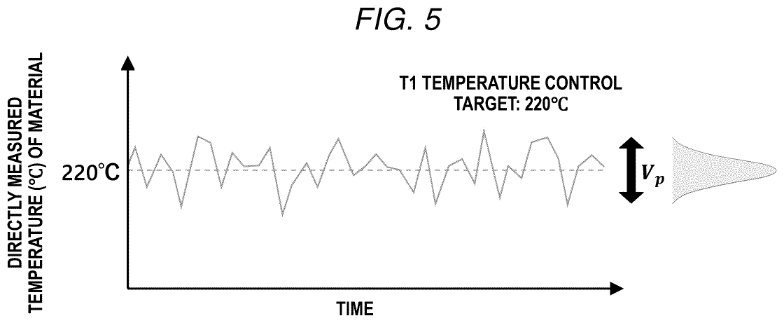

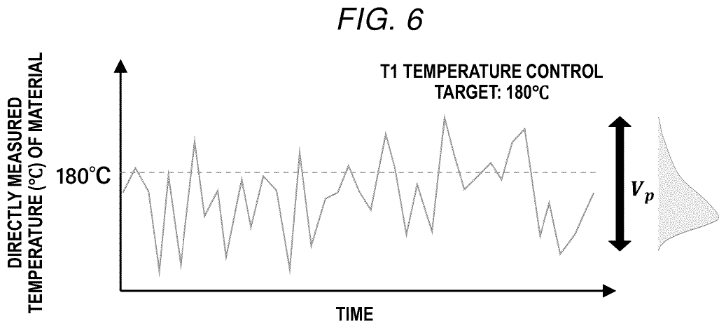

(1-3): Within the range from the lower variation limit (Xn−Vpnm) to the upper variation limit (Xn+Vpnp) of the operating condition parameter Xn, predicted characteristic values of all points are calculated according to the number of steps specified in advance by the user US or the number of steps initially set in the system, and the predicted characteristic values of all points are used as the predicted characteristic value distribution 7 for the variation amount of the n-th type. For example, in each temperature temporal variation shown in FIGS. 5 and 6 later, measured temperatures are sampled at predetermined time intervals, the predicted characteristic value is calculated using the sampled measured temperatures, and the calculated values are used as the predicted characteristic value distribution 7 for the variation amount of the n-th type.

In a general predictor using a trained model, the set operating condition X is an input, and the predicted characteristic value g(X) of the product is an output, and in the present embodiment, the predicted characteristic value distribution 7 reflecting the variation amount component Vpn of the operating conditions X is obtained.

Next, the target characteristic value setting unit 6 causes the objective function setting unit 15 to calculate an objective function f(X, Vp) based on a difference between the target characteristic value T and the predicted characteristic value distribution 7 (A5). As methods for creating the objective function f(X, Vp), there are two methods below.

(2-1): A mean squared error (MSE) between each value in the predicted characteristic value distribution 7 and the target characteristic value T is used as the objective function. That is, f(X, Vp)=Σ(g(X, Vp)−T)\hat{ }2.

(2-2): A mean absolute error (MAE) between each value in the predicted characteristic value distribution 7 and the target characteristic value T is used as the objective function. That is, f(X, Vp)=Σ|g(X, Vp)−T|.

Next, an explorer 8 explores the operating condition X that minimizes the objective function f(X, Vp) (A6). Numerical minimization is performed by an iterative method, and various algorithms can be applied. The algorithms are roughly classified into a gradient method and a non-gradient method, and a Broyden-Fletcher-Goldfarb-Shanno (BFGS) method or the like is used as the gradient method, and a Nelder-Mead method or the like is used as the non-gradient method. As an initial operating condition X₀, a value input in advance by the user US or a value initially set in the system is used. During the exploration, the processing of (A1) to (A5) is repeated.

Finally, an output unit 9 outputs a proposed operating condition XS, which is an exploration result, to end the series of processing (A7). The output unit 9 may be a user interface such as a display or a speaker.

### Hardware Structure

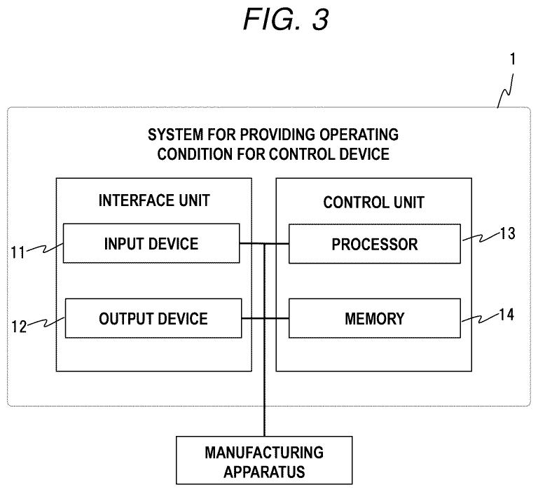

An example of a configuration of the system 1 that provides an operating condition for a control device will be described with reference to FIG. 3. As shown in FIG. 3, the system 1 that provides the operating condition for the control device according to the present embodiment is a computer connected to an input device 11 and an output device 12 as interface units, a processor 13 as a control unit, and a memory 14. The system 1 that provides the operating condition for the control device is connected to the manufacturing apparatus ME, and can read values of various sensors and perform device control according to various operating condition setting values.

In the system 1 in FIG. 2, a function indicated by a thick frame in a block is implemented by the processor 13 by executing calculation based on software stored in the memory 14 or by dedicated hardware. In the system 1 in FIG. 2, information indicated by a thin frame in a block may be stored in the memory 14 as data. Here, the processor 13 refers to a configuration that executes various types of calculation, and includes a central processing unit (CPU), a graphics processing unit (GPU), a field programmable gate array (FPGA), an application specific integrated circuit (ASIC), or the like.

### First Embodiment

In a first embodiment, it is conceivable that a twin screw extruder is used as a plastic manufacturing apparatus, and a method for providing an operating condition for the manufacturing apparatus in the embodiment is used to accurately control and manage a resin temperature. During an operation of the twin screw extruder, it is generally not easy to measure the resin temperature inside the twin screw extruder. Examples of a direct measurement method include a method of providing a thermometer on an adapter or an inner wall, and a method of directly measuring a temperature of an extruded material at an outlet of the extruder, but a measured value thereof varies over time due to a disturbance and/or an external interference, and even when a time average is obtained, there is no guarantee that the time average is a spatial average representing the resin temperature inside the extruder.

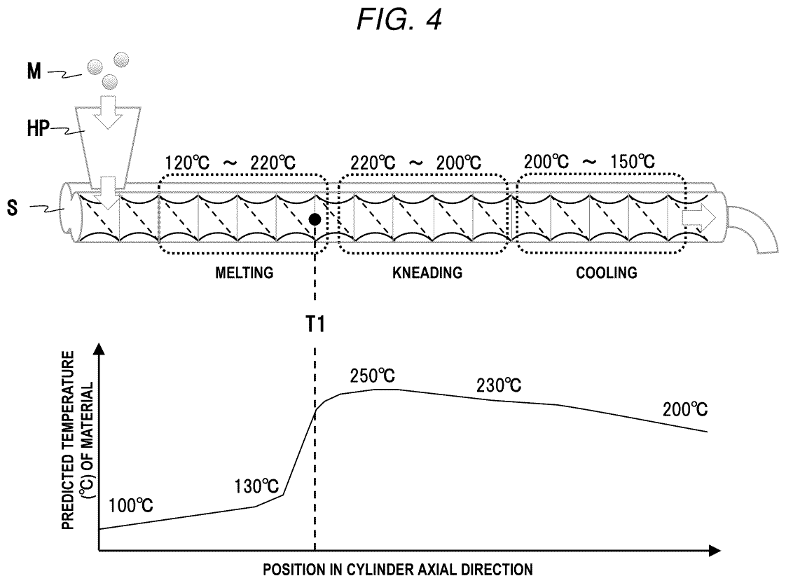

FIG. 4 shows an example of a temperature control state of each cylinder zone of a cylinder S of the twin screw extruder and a predicted value of an internal material temperature by a simulation. Each temperature shown at an upper part of the cylinder S in the extruder in FIG. 4 is a control temperature target value of the cylinder S. The operating condition X related to the temperature can be set for each cylinder zone. In this case, since there are a plurality of operating conditions, for example, there is a method of sequentially determining the operating conditions by assigning priorities from those having a largest impact on a quality characteristic.

In the example in FIG. 4, a raw material M introduced from a hopper HP is first guided to a zone intended for melting, receives energy from an inner wall of the cylinder controlled to have a high temperature, and is dissolved. Here, since the raw material is a solid phase, all of a solid phase, a liquid phase, and a gaseous phase are present in the cylinder until the raw material is dissolved. The dissolved material is gradually melted and kneaded in the melting zone, and is guided directly into a zone intended for continuous kneading.

In this kneading zone, a screw configuration generates a high-pressure state using a reverse kneading screw or the like, a volume ratio of a gaseous phase is small and a fill rate is high. Not only a cylinder temperature but also viscous heat generated by rotation of the screw causes the material to generate heat. The material sufficiently kneaded in the kneading zone is finally guided to a cooling zone.

In the cooling zone, a material temperature is higher than a cylinder inner wall temperature, and the material is gradually cooled through the inner wall of the cylinder. The material temperature inside the cylinder and a temperature control target of the cylinder are not necessarily the same value.

It is assumed that one temperature sensor is inserted into a position Ti in FIG. 4. An actual material temperature at a position slightly before switching from the melting zone to the kneading zone in a region where a pressure increases is important information.

FIG. 5 shows a change over time in a value observed by the inserted temperature sensor. A temperature observed by the temperature sensor inserted at the position Ti is 220° C., which is substantially the same as the temperature control target, the variation amount Vp of the temperature is small, and a temporal distribution of the temperature is in a horizontally symmetrical normal distribution centered around 220° C. It can be said that the observed temperature is most direct information regarding material temperature information inside the cylinder, but is not perfect in that the value from the temperature sensor may not have a time step that enables capturing of a disturbance on a minute scale, and that the observed temperature is only information at one point of a finite volume component inside the cylinder and does not provide any information about a distribution. Nevertheless, the observed temperature is still fairly useful for predicting an internal state of the cylinder together with temperature prediction by a simulation. Here, a case where the operating condition related to the temperature is changed is considered.

FIG. 6 shows a change over time in the value observed with the temperature sensor at the position Ti when the operating condition related to the temperature in FIG. 4 is changed and the temperature control target value at the position Ti is changed to 180° C. In FIG. 6, as compared to FIG. 5, an average observed temperature is slightly lower than the temperature control target value (180° C.), and the variation amount Vp of the temperature is large. The temporal distribution of the temperature greatly deviates from the normal distribution.

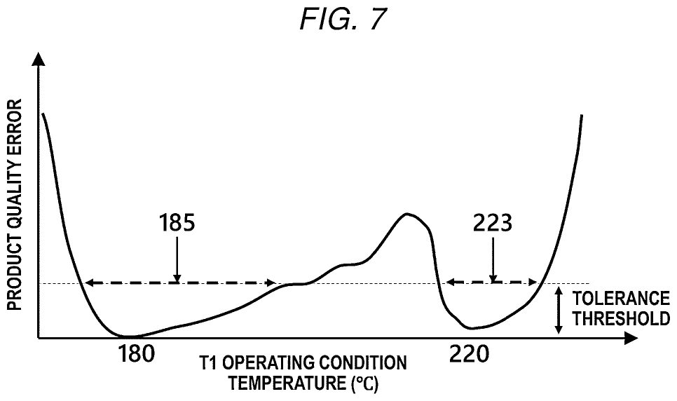

FIG. 7 is a graph showing a relationship between an operating condition temperature and product quality. It is assumed that a relationship between a Ti operating condition temperature and a product quality error as shown in FIG. 7 is known for the manufacturing apparatus and a manufacturing item showing the states of FIGS. 4, 5, and 6. When the product quality error has a small value, quality of a product thereof is favorable, and it is desired to minimize production of products having a product quality error exceeding a tolerance threshold from the manufacturing apparatus. As shown in FIG. 7, it is assumed that the product quality error has a local minimum value at temperatures of 180° C. and 220° C. It is also assumed that a median value in a temperature range in which the product quality falls within the tolerance threshold is 185° C. and 223° C. Hereinafter, it is considered what temperature is appropriate as a robust Ti operating condition temperature resistant to disturbances and external interferences in such a case.

Referring only to FIG. 7, a range of values below the tolerance threshold is wider in the vicinity of 185° C. than in the vicinity of 223° C., and it appears that setting the Ti operating condition temperature at 185° C. is more likely to maintain the product quality error within the tolerance threshold even when the temperature varies slightly. However, as shown in FIGS. 5 and 6, in a case where the Ti temperature control target is 180° C., the variation amount Vp of the temperature is large and a distribution is different as compared to a case where the Ti temperature control target is 220° C., and thus it cannot be said that the product quality error is minimized at 185° C. in general. In the first embodiment, only the temperature is one-dimensional, and in a case of being multi-dimensional, it is more difficult to derive an optimum proposed operating condition without numerical optimization computation.

A procedure for solving the above situation will be described with reference to the flowchart in FIG. 1. First, the variation amount setting unit 2 acquires information on the variation amount Vp according to the operating condition from a history data set of past extruder operating conditions and Ti sensor acquired values accumulated in the variation amount observer 3 (A1).

Thereafter, the predictor reads, from the database DB, a trained regression model in which the input is the operating condition of the extruder and the output is the characteristic value of the product manufactured from the extruder (A2). As long as the trained regression model is a regression model, the trained regression model may be a deep neural network (DNN), a gradient boosting decision tree (GBGT), a kernel ridge regulation (KRR), or the like. The trained model to be read may be a fixed model if the product manufactured by the manufacturing apparatus is fixed, and may be selected by the user US each time.

Thereafter, the user US sets the target characteristic value T of the product manufactured by the extruder through an input machine, and the target characteristic value setting unit 6 acquires a value thereof (A3). At the same time, the user US may specify and input a specific operating condition as an initial operating condition.

In the first embodiment, it is assumed that the user US sets the initial operating condition by setting the Ti temperature control target to 180° C., and intends to know whether 185° C., 220° C., 223° C., or another temperature is a better condition. Thereafter, computation starts, and the trained model outputs the predicted characteristic value distribution 7 in consideration of the variation amount (A4).

Thereafter, the objective function setting unit 15 calculates an objective function f based on a difference between the target characteristic value T and the predicted characteristic value distribution 7 (A5). In the first embodiment, it is considered that the quality of the product manufactured by the extruder is better as the product quality approaches the target characteristic value T, and thus a form is adopted in which the mean squared error MSE is the objective function f.

Thereafter, the explorer 8 explores an operating condition that minimizes the objective function f (A6). In the first embodiment, since it is known that there is a region where the product quality error is large between 185° C. and 220° C. as the Ti operating condition temperature, a Nelder-Mead method that is a non-gradient method is selected as an exploration algorithm instead of a gradient method, which is based on a gradient and moves toward a local minimum value.

After the exploration by the explorer 8 ends, the proposed operating condition XS is obtained and is presented to the user US, and thus the proposed operating condition XS is output by the output unit 9 (A7). With this series of flows, it is possible to provide an optimum operating condition for each manufacturing apparatus ME, which is resistant to variations such as disturbances and external interferences.

In the above description, the Ti operating condition temperature is used as the operating condition parameter Xn, the objective function f is calculated by the methods (2-1) and (2-2), and the optimum operating condition is obtained. In an actual apparatus, as shown in FIG. 4, the operating condition temperature differs depending on a location and a condition, and there may be m operating condition parameters such as X1 to Xm operating condition temperatures.

In this way, there are a plurality of operating conditions for one manufacturing apparatus, and each of the operating conditions may be a set temperature at a different location of the manufacturing apparatus. At this time, the explorer 8 explores a set temperature that reduces the objective function for each operating condition. At this time, the operating conditions are determined in an order from a temperature having a large impact on the quality characteristic, for example, by giving priority to optimization of the cooling zone. Alternatively, the operating conditions are optimized by exploring a condition that minimizes a sum of objective functions of all the operating conditions.

### Second Embodiment

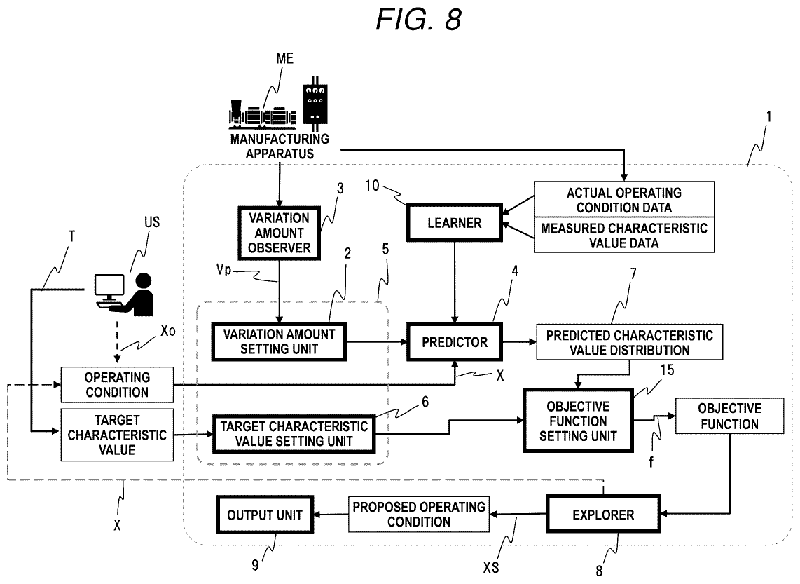

FIG. 8 is a functional block diagram of a system that provides an optimum operating condition for each manufacturing apparatus, the system including a variation amount observer that has actual operating condition data executed in the past in the manufacturing apparatus and measured characteristic value data associated with the actual operating condition data, and that observes a variation amount of the manufacturing apparatus.

A basic configuration is the same as that in FIG. 2, but is different in that (8-1) a self-trained model is constructed using supervised learning from the actual operating condition data and the measured characteristic value data using the system, instead of reading the trained model from the database, and (8-2) the variation amount observer including hardware such as a temperature sensor or a pressure sensor is provided in the system.

(8-1): A learner 10 has past actual operating condition data and measured characteristic value data in a manufacturing apparatus associated with the system, and constructs a self-trained model by supervised learning using all or a part of the data.

As the actual operating condition data, data measured by the variation amount observer 3 is used. The measured characteristic value data is obtained by separately sampling a product and measuring a characteristic by a known method. These pieces of data can be organized into a database by accumulating past data.

Learning performed by the learner 10 at this time may be any machine learning method such as deep learning, kernel ridge regression, or multiple regression. In addition, training data used for learning is usually subjected to filtering by an item to be manufactured, time, or the like, and the filtering can be performed automatically or manually. The self-trained model constructed by the learner 10 may be stored in a trained database as shown in FIG. 2 for use on another occasion.

(8-2): The variation amount observer includes hardware of a physical sensor, such as a temperature measuring instrument, and stores time-series data of a physical quantity acquired from the sensor. Based on user setting or an initial setting value, the variation amount setting unit performs filtering based on manufacturing date and time, an environment record, or the like from data retained by the variation amount observer, and then calculates the variation amount. Here, the environment record includes apparatus-specific apparatus transfer date and time, an apparatus-specific date and time record of part modification and repair, and the like that are considered to affect external interferences and disturbances.

### Third Embodiment

In the above-described embodiments, examples of the extruder are described. However, the invention may also be applied to a technical field of producing a product by modifying another raw material. For example, in a bread baking machine, an internal fermentation state by yeast in bread dough is a fairly important parameter, and a temperature of bread dough is an example of an important indicator for determining fermentation. However, actually, it is not easy to control the temperature by accurately measuring or estimating a temperature distribution of bread dough in the machine.

It is possible to appropriately control the fermentation state of bread dough by basically the same method as in the first embodiment and the second embodiment.

As described in detail above, in the present embodiment, the trained model that predicts the characteristic value being the processing result of a workpiece from the operating condition is used, the predicted characteristic value distribution in consideration of the variation amount is calculated from the model, and the operating condition optimization that minimizes the objective function related to the difference between the target characteristic value and the predicted characteristic value distribution is performed, and thus it is possible to provide a robust operating condition resistant to disturbances and external interferences.

That is, according to the present embodiment, it is not necessary for the user to explore and set the operating condition in consideration of an apparatus specification, an installation environment that differs for each apparatus, and an individual part difference that may affect a processing result even when there are such machine-specific factors. As an additional effect, it is possible to reduce a probability of selecting a stationary point such as a local maximum value or a saddle point as an optimum solution in operating condition optimization computation.

According to the above-described embodiments, since an efficient manufacturing technique can be provided, less energy is consumed, carbon emission is reduced, and global warming is prevented, which contributes to implementation of a sustainable society.

What is claimed is:

1. A method for providing an operating condition for a manufacturing apparatus that manufactures a product using an input device, an output device, a processor, and a memory, the method comprising:
a variation amount input step in which the input device inputs a variation amount related to a predetermined operating condition;
a model reading step in which the processor reads, from the memory, a model in which an input is the operating condition and an output is a characteristic value of the product;
a target characteristic value input step in which the input device inputs a target characteristic value of the product;
a predicted characteristic value distribution calculation step in which the processor calculates, using the model, a predicted characteristic value distribution reflecting the variation amount related to the predetermined operating condition;
an objective function calculation step in which the processor calculates an objective function based on the predicted characteristic value distribution and the target characteristic value;
an operating condition exploration step in which the processor explores the predetermined operating condition that reduces the objective function; and
an operating condition output step of outputting an operating condition that is a result of the exploration.

2. The method for providing an operating condition for a manufacturing apparatus according to claim 1, wherein
the manufacturing apparatus manufactures the product by modifying a raw material.

3. The method for providing an operating condition for a manufacturing apparatus according to claim 1, wherein
the predetermined operating condition is a set value of a predetermined physical quantity, and the variation amount is a variation amount from the set value of the predetermined physical quantity.

4. The method for providing an operating condition for a manufacturing apparatus according to claim 3, wherein
the predetermined operating condition is a set temperature at a predetermined location of the manufacturing apparatus, and the variation amount is a variation amount from the set temperature.

5. The method for providing an operating condition for a manufacturing apparatus according to claim 3, wherein
in the predicted characteristic value distribution calculation step, two points are calculated, that is, a lower variation limit predicted characteristic value g(Xn−Vpnm) and an upper variation limit predicted characteristic value g(Xn+Vpnp), and the two points are used as the predicted characteristic value distribution, where
the input of the model is an operating condition X, and the output of the model is a characteristic value g(X) of the product, and
Vpnp is an absolute value of a maximum positive variation value, and Vpnm is an absolute value of a maximum negative variation value of the variation amount based on the set value Xn of the predetermined physical quantity.

6. The method for providing an operating condition for a manufacturing apparatus according to claim 3, wherein
in the predicted characteristic value distribution calculation step, the characteristic value is calculated at an exploration point selected by a design-of-experiments method according to a specified number of explorations in a range from a lower variation limit predicted characteristic value g(Xn−Vpnm) to an upper variation limit predicted characteristic value g(Xn+Vpnp), and the calculated characteristic value is used as the predicted characteristic value distribution, where
the input of the model is the operating condition X, and the output of the model is the characteristic value g(X) of the product, and
Vpnp is an absolute value of a maximum positive variation value, and Vpnm is an absolute value of a maximum negative variation value of the variation amount based on the set value Xn of the predetermined physical quantity.

7. The method for providing an operating condition for a manufacturing apparatus according to claim 3, wherein
in the predicted characteristic value distribution calculation step, data of a predetermined number of points is sampled from the variation amount related to the predetermined operating condition in a range from a lower variation limit predicted characteristic value g(Xn−Vpnm) to an upper variation limit predicted characteristic value g(Xn+Vpnp), the characteristic value is calculated based on the sampled data, and the calculated characteristic value is used as the predicted characteristic value distribution, where
the input of the model is the operating condition X, and the output of the model is the characteristic value g(X) of the product, and
Vpnp is an absolute value of a maximum positive variation value, and Vpnm is an absolute value of a maximum negative variation value of the variation amount based on the set value Xn of the predetermined physical quantity.

8. The method for providing an operating condition for a manufacturing apparatus according to claim 3, wherein
in the objective function calculation step, a mean squared error between each value in the predicted characteristic value distribution and the target characteristic value is used as the objective function.

9. The method for providing an operating condition for a manufacturing apparatus according to claim 3, wherein
in the objective function calculation step, a mean absolute error between each value in the predicted characteristic value distribution and the target characteristic value is used as the objective function.

10. The method for providing an operating condition for a manufacturing apparatus according to claim 3, wherein
a plurality of the predetermined operating conditions are provided for one manufacturing apparatus, and
the variation amount input step, the model reading step, the predicted characteristic value distribution calculation step, the objective function calculation step, the operating condition exploration step, and the operating condition output step are executed for each of the plurality of predetermined operating conditions.

11. A system for providing an operating condition for a manufacturing apparatus that manufactures a product from a raw material, the system comprising:
a variation amount setting unit configured to receive, from an input machine, a variation amount related to a predetermined operating condition;
a predictor configured to receive the predetermined operating condition and the variation amount, and output a predicted characteristic value distribution of the product using a model in which an input is an operating condition and an output is a characteristic value of the product;
a target characteristic value setting unit configured to receive, from the input machine, a target characteristic value that is a target characteristic value of the product;
an objective function setting unit configured to set an objective function based on the predicted characteristic value distribution and the target characteristic value;
an explorer configured to explore the predetermined operating condition that reduces the objective function; and
an output unit configured to output the explored operating condition.

12. The system for providing an operating condition for a manufacturing apparatus according to claim 11, further comprising:
a training machine configured to generate a self-trained model by performing supervised learning using actual operating condition data and measured characteristic value data actually acquired from the manufacturing apparatus, wherein
the predictor uses the self-trained model as the model.

13. The system for providing an operating condition for a manufacturing apparatus according to claim 11, wherein
the predetermined operating condition is a set temperature at a predetermined location of the manufacturing apparatus, and the variation amount is a variation amount from the set temperature.

14. The system for providing an operating condition for a manufacturing apparatus according to claim 13, wherein
the explorer explores a set temperature at a predetermined location of the manufacturing apparatus to reduce the objective function.

15. The system for providing an operating condition for a manufacturing apparatus according to claim 14, wherein
a plurality of the predetermined operating conditions are provided for one manufacturing apparatus,
the predetermined operating conditions are set temperatures at different locations of the manufacturing apparatus, and
the explorer explores a set temperature that reduces the objective function for each of the predetermined operating conditions.
